(19) United States
(12) Patent Application Publication
(10) Pub. No.: US 2020/0182199 A1
(43) Pub. Date: Jun. 11, 2020

(54) FLOW CONTROL VALVE AND FUEL VAPOR TREATING DEVICE

(71) Applicant: DENSO CORPORATION, Kariya-city (JP)

(72) Inventor: Hirofumi ONODERA, Kariya-city (JP)

(21) Appl. No.: 16/705,461

(22) Filed: Dec. 6, 2019

(30) Foreign Application Priority Data
Dec. 10, 2018 (JP) 2018-231056

(51) Int. Cl. F02M 25/08; B60K 15/03; F02M 35/10; F16K 1/36; F16K 1/02; B01D 53/04

(52) U.S. Cl. CPC F02M 25/0836; F02M 25/0854; B60K 15/03; F02M 25/0872; B01D 2259/4516; F16K 1/36; F16K 1/02; B01D 53/0446; F02M 35/10222

(57) ABSTRACT

A flow control valve has a housing, a valve element, a drive member, a drive-member thread, a valve thread, a drive-member detent part, and a valve detent part. A direction where the valve element gets close to a valve seat is a positive direction and an opposite is a negative direction. A first value is a value indicating a distance from an end of the drive-member detent part in the positive direction to an end of the drive-member thread in the positive direction, and a second value is a value indicating a distance from an end of the valve detent part in the negative direction to an end of the valve thread in the negative direction. The second value is larger than the first value.

### CROSS REFERENCE TO RELATED APPLICATION

This application is based on Japanese Patent Application No. 2018-231056 filed on Dec. 10, 2018, the disclosure of which is incorporated herein by reference in its entirety.

### TECHNICAL FIELD

The present disclosure relates to a flow control valve and a fuel vapor treating device.

### BACKGROUND

A fuel control valve has a stepping motor and drives a valve element with a feed screw mechanism. The fuel control valve opens and closes a passage by letting a seal member below the valve element get close to or away from a valve seat. The valve element is disposed movable in an axial direction with fixed in a circumferential direction by a detent mechanism. The detent mechanism enables the valve element not to be rotated together with the stepping motor. The detent mechanism may work by engaging a recess on the stepping motor with a projection on the valve element in a circumferential direction.

### SUMMARY

A flow control valve has a housing, a valve element, a drive member, a drive-member thread, a valve thread, a drive-member detent part, and a valve detent part. The valve element can get in contact with or be separated from a valve seat of the housing. The drive member reciprocates the valve element. The drive-member thread is located at a power transmission shaft connecting the drive member and the valve element for power transmission. The valve thread is located at the valve element, engaged with the drive-member thread, and forms a feed screw mechanism with the drive-member thread. The drive-member detent part is located at the drive member, engaged with the valve detent part, and forms a detent mechanism with the valve detent part. The detent mechanism regulates the rotation of the valve element relative to an axis in a circumferential direction.

A direction where the valve element gets in contact with the valve seat is defined as a positive direction. A direction where the valve element is separated from the valve seat is defined as a negative direction. An end M1 is an end of the drive-member detent part in the positive direction. An end M2 is an end of the drive-member thread in the positive direction. A first value L1 is a positive or negative value indicating a distance from the end M1 as a start point to the end M2. An end V1 is an end of the valve detent part in the negative direction and an end V2 is an end of the valve thread in the negative direction. A second value L2 is a positive or negative value indicating a distance from the end V1 as a start point to the end V2. The second value L2 is larger than the first value L1.

### BRIEF DESCRIPTION OF THE DRAWINGS

FIG. 1 is a schematic view of a fuel vapor treating device.

FIG. 2 is a cross section view of a flow control valve in accordance with the first embodiment at a valve closed time.

FIG. 3 is a cross section view taken along the line III-III in FIG. 2.

FIG. 4 is a cross section view of the flow control valve in accordance with the first embodiment at a valve opened time.

FIG. 5 is a schematic view illustrating a state before a valve element is assembled with a motor.

FIG. 6 is a schematic view illustrating a state when detent mechanisms are engaged.

FIG. 7 is a schematic view illustrating a state when feed screw mechanisms are engaged.

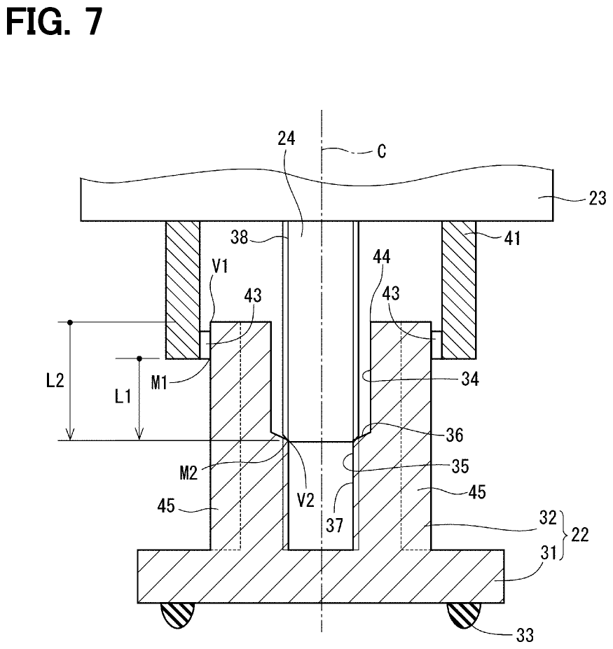

FIG. 8 is a cross section view of a flow control valve in accordance with the second embodiment at a valve closed time.

FIG. 9 is a schematic view illustrating a state before a valve element in accordance with the second embodiment is assembled with a motor.

FIG. 10 is a schematic view illustrating a state when detent mechanisms are engaged in accordance with the second embodiment.

### DETAILED DESCRIPTION

To begin with, examples of relevant techniques will be described.

A fuel vapor treating device collects fuel vapor in a fuel tank and supplies the vapor with an intake system of an internal combustion engine. The fuel vapor treating device has the fuel tank, a canister, a vapor passage connecting the fuel tank and the canister, and a flow control valve disposed in the vapor passage. The flow control valve closes the vapor passage while a vehicle is parked and opens the vapor passage while the vehicle is refueled.

A fuel control valve has a stepping motor and drives a valve element with a feed screw mechanism. The fuel control valve opens and closes a passage by letting a seal member below the valve element get close to or away from a valve seat. The valve element is disposed movable in an axial direction with fixed in a circumferential direction by a detent mechanism. The detent mechanism enables the valve element not to be rotated together with the stepping motor. The detent mechanism may work by engaging a recess on the stepping motor with a projection on the valve element in a circumferential direction.

The feed screw mechanism has a male thread formed at a shaft of the stepping motor and a female thread formed around an inner peripheral part of a tube part of the valve element. The male thread is engaged with the female thread. An end of the shaft of the stepping motor protrudes toward the valve seat over the detent mechanism. The male thread is still located at the end of the shaft on the valve seat side. The female thread is still located at an end of the tube part of the valve element on the stepping motor side.

However, in the flow control valve described above, the feed screw mechanism works first before the detent mechanism works in assembling the shaft of the stepping motor and the valve element. Thus, in assembling the flow control valve, a regulation of a rotation for either of the male thread or the female thread is required not to let them be rotated together. For example, a jig for regulating the rotation of the valve element is required until the detent mechanism starts to work. This makes the assembly complex, time-consuming, and inefficient.

The present disclosure provides a flow control valve that improves an efficiency of the assembly.

A fuel vapor treating device has a fuel tank and a canister configured to absorb fuel vapor generated in the fuel tank. A flow control valve is provided at a vapor passage that connects the canister and the fuel tank.

The flow control valve has a housing, a valve element, a drive member, a drive-member thread, a valve thread, a drive-member detent part, and a valve detent part. The housing has a passage through which fuel vapor flows from a fuel tank passage to a canister passage. The fuel tank passage connects a fuel tank with the flow control valve. The canister passage connects the flow control valve with a canister. The valve element can get in contact with or be separated from a valve seat of the housing. The valve element closes the passage between the fuel tank passage and the canister passage so that the fuel vapor does not flow into the canister passage. The valve element opens the passage between the fuel tank passage and the canister passage so that the fuel vapor flows into the canister passage.

The drive member reciprocates the valve element to get in contact with or be separated from the valve seat. The drive-member thread is located at a power transmission shaft connecting the drive member and the valve element for power transmission. The valve thread is located at the valve element, engaged with the drive-member thread, and forms a feed screw mechanism with the drive-member thread. The drive-member detent part is located at the drive member, engaged with the valve detent part, and forms a detent mechanism with the valve detent part. The detent mechanism regulates the rotation of the valve element relative to an axis in a circumferential direction.

A direction where the valve element gets in contact with the valve seat is defined as a positive direction. A direction where the valve element is separated from the valve seat is defined as a negative direction. An end M1 is an end of the drive-member detent part in the positive direction. An end M2 is an end of the drive-member thread in the positive direction. A first value L1 is a positive or negative value indicating a distance from the end M1 as a start point to the end M2. For example, when the end M2 is located in the positive direction from the end M1, the first value L1 has a positive value. When the end M2 is located in the negative direction from the end M1, the first value has a negative value. An end V1 is an end of the valve detent part in the negative direction and an end V2 is an end of the valve thread in the negative direction. A second value L2 is a positive or negative value indicating a distance from the end V1 as a start point to the end V2. The second value L2 is larger than the first value L1.

In this embodiment, the positions of the detent mechanism and the feed screw mechanism are defined so that the second value L2 is larger than the first value L1. In assembling the flow control valve, the detent mechanism works first and then the feed screw mechanism works. Thus, until the detent mechanism starts to work, it is no need to regulate a rotation of the valve element relative to the axis in the circumferential direction and have a tool for regulating the rotation. Thus, the assembly is to be simple, efficient, and improved.

Embodiments of the present disclosure will be described referring to the drawings.

### First Embodiment

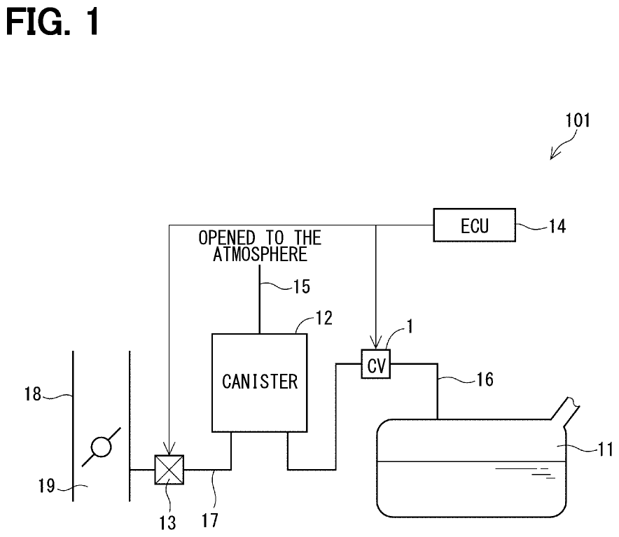

The first embodiment is explained with reference to FIGS. 1 to 3. As shown in FIG. 1, a fuel vapor treating device 101 has a flow control valve 1, a fuel tank 11, a canister 12, a purge valve 13, and an electronic control unit (ECU) 14.

The fuel tank 11 is disposed in a vehicle and stores fuel supplied to an internal combustion engine 18. The canister 12 has an absorbent (not shown) collecting fuel vapor generated in the fuel tank 11. The canister 12 operates a purging. In the purging, the fuel vapor flows to the canister 12 through the vapor passage 16. The fuel vapor is absorbed at the absorbent in the canister 12 and flows further to a purge passage 17 with an air taken through an air passage 15. Then, the fuel vapor and the air flow to an intake passage 19 in the internal combustion engine 18. The vapor passage 16 is a passage connecting the fuel tank 11 and the canister 12, and has the flow control valve 1. The purge passage 17 has a purge valve 13. The purge valve 13 controls an amount of the fuel vapor purged from the canister 12 to the intake passage 19 by regulating an opening degree of the purge valve 13.

For example, the flow control valve 1 keeps closing the vapor passage 16 while the vehicle is parked. Thus, the fuel vapor in the fuel tank 11 does not flow into the canister 12. The flow control valve 1 keeps opening the vapor passage 16 during refueling. For example, the refueling includes opening a cap of the fuel tank 11, filling fuel in the fuel tank 11, and finishing the filling. During the refueling, the fuel vapor in the fuel tank 11 flows through the vapor passage 16 and sticks to the absorbent in the canister 12. The flow control valve 1 is operated to control a communication between the fuel tank 11 and the canister 12. The ECU 14 electrically connects the flow control valve 1 and the purge valve 13, and controls an opening and closing of the flow control valve 1 and the purge valve 13.

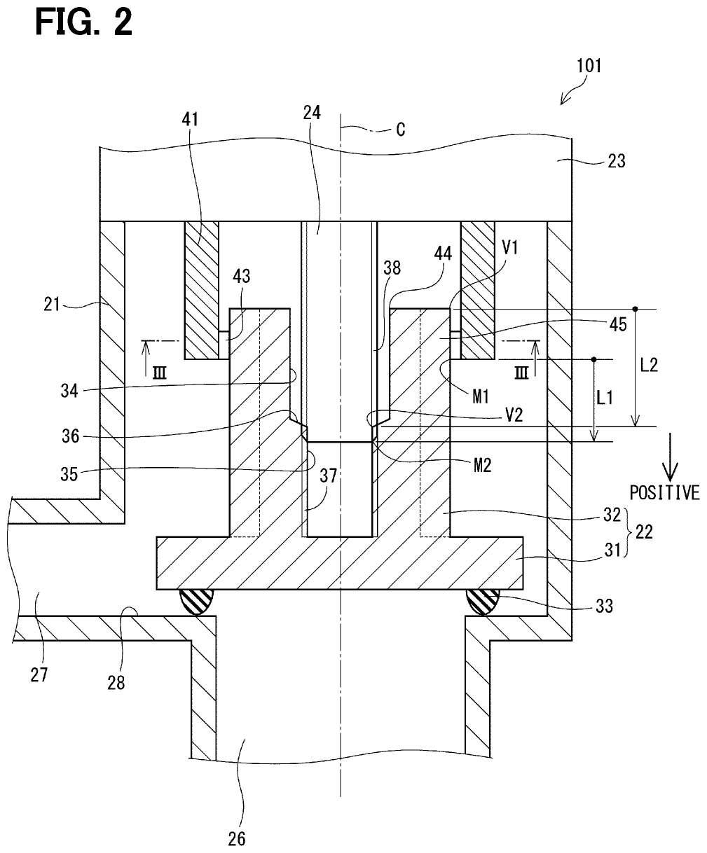

The structure of the flow control valve is explained with reference to FIG. 2. FIG. 2 is a cross section view of the flow control valve while the flow control valve opens the passage and a line behind the cross section is omitted. The flow control valve 1 has a housing 21, a valve element 22, a motor 23, and a motor shaft 24. The housing 21 has an approximately circular tube shape and the passage through which the fuel vapor flows from a fuel tank passage 26 to a canister passage 27. The fuel tank passage 26 is a passage connecting the housing 21 and the fuel tank 11. The canister passage 27 is a passage connecting the housing 21 and the canister 12. The housing 21 has a valve seat 28 defined by a plain surface that extends from an edge of an opening of the fuel tank passage 26 in a direction orthogonal to the moving direction of the valve element 22.

The valve element 22 closes a passage between the fuel tank passage 26 and the canister passage 27 to prevent the fuel vapor from flowing into the canister passage 27. The valve element 22 opens the passage between the fuel tank passage 26 and the canister passage 27 to allow the fuel vapor flow into the canister passage 27.

As shown in FIG. 2, the valve element 22 has a bottom wall 31 having a circular plate shape and a tube part 32. The bottom wall 31 and the tube part 32 have a center axis C in common. The bottom wall 31 is located closer to the valve seat 28 than the tube part 32 is, and integrally formed with the tube part 32. The bottom wall 31 has a rubber seal member 33 combined with the bottom wall 31 on a surface facing the valve seat 28.

A center of the tube part 32 has a large diameter hole 34 and a small diameter hole 35 in which the motor shaft 24 is inserted. The large diameter hole 34 is located closer to the motor 23 than the small diameter hole 35 is. The large diameter hole 34 and the small diameter hole 35 define one continuous opening and are coaxially provided to the bottom wall 31. The large diameter hole 34 has a larger diameter than the small diameter hole 35. A part of a side wall of the large diameter hole 34 on the valve seat side has a taper wall 36 which is gentry tapered toward the small diameter hole 35. An inner peripheral part of the small diameter hole 35 has a female thread 37. The female thread 37 corresponds to the valve thread.

The motor shaft 24 is inserted in the large diameter hole 34 and the small diameter hole 35. The motor shaft 24 has a male thread 38 around an outer peripheral part, which is engaged with the female thread 37 of the small diameter hole 35. The male thread 38 corresponds to the drive-member thread. The male thread 38 and the female thread 37 form the feed screw mechanism that reciprocates the valve element 22 in the axis direction. An inner peripheral part of the large diameter hole 34 does not have the female thread 37, which disables the large diameter hole 34 for being engaged with the motor shaft 24. The large diameter hole 34 corresponds to an escape space that houses the motor shaft 24 not to be engaged with the male thread 38.

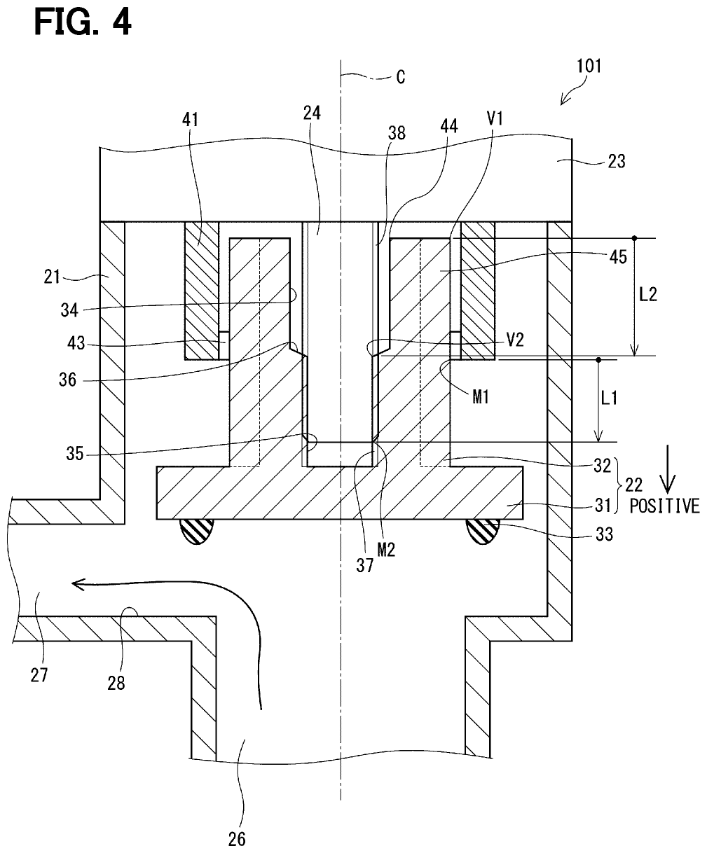

The motor 23 is located outside the housing 21 in contact with an upper wall of the housing 21. The motor 23 rotates the motor shaft 24 in a specified direction, which moves the valve element 22 in a closing direction or an opening direction. The closing direction is a direction where the valve element 22 gets close to the valve seat 28 and the opening direction is a direction where the valve element 22 is separated from the valve seat 28. Such reciprocating movement of the valve element 22 allows the rubber seal member 33 of the valve element 22 get in contact with or be separated from the valve seat 28. FIG. 4 shows a valve opened state, where the valve element 22 is located furthest from the valve seat 28. A curved line with an arrow in FIG. 4 is one example of a moving path of the fuel vapor.

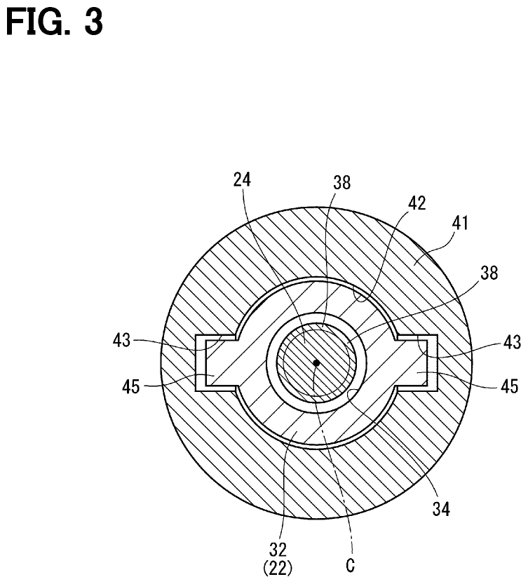

In FIG. 2, a bottom surface of the motor 23 has a cylindrical projection 41 protruded toward an inside the housing 21. The cylindrical projection 41 has a bottomed cylindrical shape and houses the motor shaft 24. A center of the bottom of the cylindrical projection 41 has a storage hole 42 (shown in FIG. 3) that houses the tube part 32 of the valve element 22. An inner surface of the bottom of the cylindrical projection 41 forming the storage hole 42 has a detent recess 43. The detent recess 43 is recessed from the inner surface of the cylindrical projection 41 outward in a radial direction. The detent recess 43 has a rectangular parallelepiped cross section in the axial direction. As shown in FIG. 3, the detent recess 43 is symmetrically formed at two places relative to the center axis C. For example, the two detent recesses 43 are distanced from each other by 180 degrees in the circumferential direction of the cylindrical projection 41. The detent recess 43 corresponds to the drive-member detent part.

The tube part 32 of the valve element 22 has an end portion 44 that surrounds the opening defined by the large diameter hole 34, on the motor 23 side. The end portion 44 has a detent projection 45. The detent projection 45 protrudes outward in the radial direction orthogonal to a direction of the reciprocate movement of the valve element 22. The detent projection 45 has a shape capable of being engaged with the detent recess 43. The detent projection 45 has the same rectangular parallelepiped cross section with the detent recess 43 in the axial direction. The detent projections 45 are symmetrically provided in two places relative to the center axis, and separated from each other by 180 degrees in the circumferential direction of the tube part 32. The detent projection 45 corresponds to the valve detent part.

When the detent projection 45 is engaged with the detent recess 43, the valve element 22 is locked in the circumferential direction. Thus, the valve element 22 can move in the axial direction without being rotated together with the motor shaft 24. The detent projection 45 and the detent recess 43 form the detent mechanism for the valve element 22. The motor shaft 24 connects the motor 23 with the valve element 22, and allows the motor 23 to transmit a rotating power to the valve element 22.

A positive direction is defined as a direction where the valve element 22 gets in contact with the valve seat 28. A negative direction is defined as a direction where the valve element 22 is separated from the valve seat 28. The positive direction is a down direction and the negative direction is an up direction in FIG. 2. An end M1 is an end of the detent recess 43 in the positive direction and an end M2 is an end of a contact part where the male thread 38 is engaged with the female thread 37 in the positive direction. A first value L1 is a positive or negative value indicating a distance from the end M1 as a start point to the end M2. For example, the end M2 is located in the positive direction from the end M1, the first value has a positive value. When the end M2 is located in the negative direction from the end M1, the first value has a negative value. An end V1 is an end of the detent projection 45 in the negative direction and an end V2 is an end of a contact part where the female thread 37 is engaged with the male thread 38 in the negative direction. A second value L2 is a value indicating a distance from the end V1 as a start point to the end V2 in the axial direction. In this embodiment, the second value L2 is larger than the first value L1.

In this embodiment, an end of the motor shaft 24 in the positive direction, or the end M2 is located closer to the valve seat 28 than the end M1 of the motor detent part is. The second value L2 is the same with a depth of the large diameter hole 34 in the axial direction. A first distance between the end M1 and the end M2 is smaller than a second distance between the end V1 and the end V2. Assembly procedure

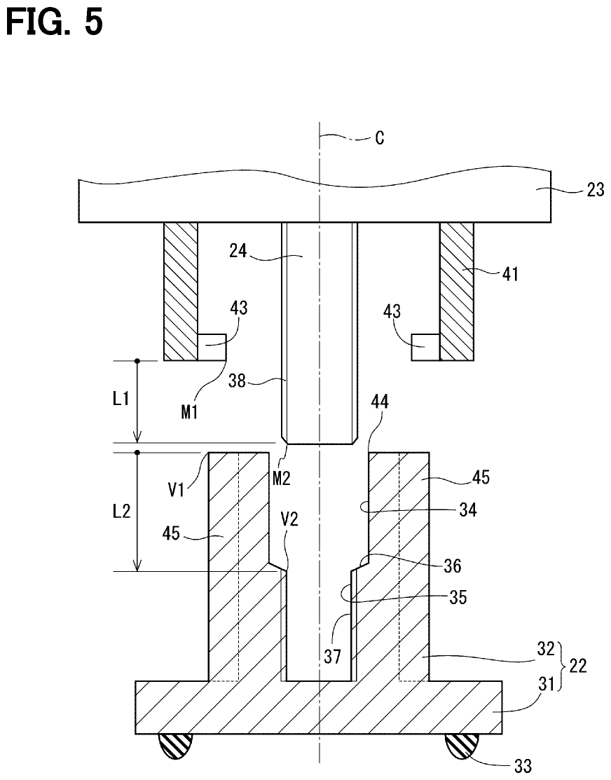

An assembly procedure of the flow control valve 1 is described below. As shown in FIG. 5, the valve element 22 located away from the motor 23 is gradually approached to the motor 23, for example, by an assembly tool. At this time, the large diameter hole 34 and the small diameter hole 35 of the valve element 22 approximately come alignment with the motor shaft 24 in the axial direction.

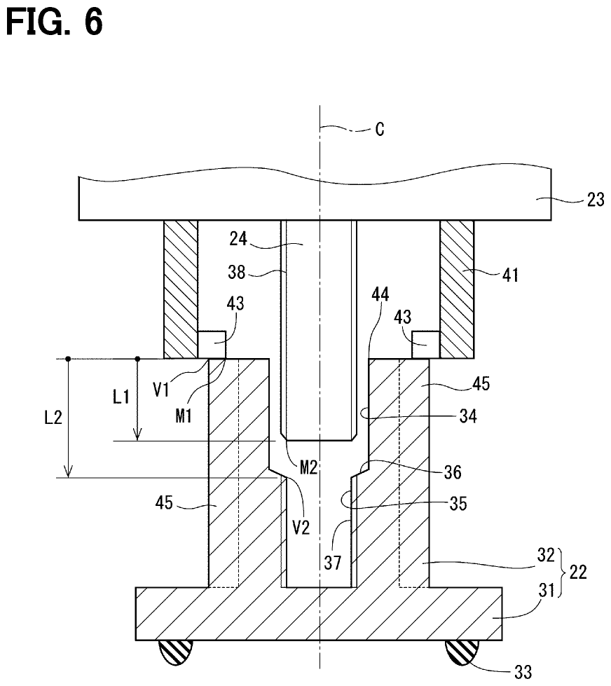

FIG. 6 explains a start point that the detent mechanism works. The end V1 of the valve detent part and the end M1 of the motor detent part will get the same position in the axial direction as shown in FIG. 6. When the detent projection 45 corresponds to the detent recess 43 in the axial direction, they will be engaged with each other. When the detent projection 45 is located another position with the detent recess 43 in the axial direction, the valve element 22 or the motor 23 is rotated appropriately relative to the axis and the detent recess 43 or the detent projection 45 is repositioned to be engaged with each other.

After the detent mechanism works, the valve element 22 can be inserted deeper to the motor 23. The end V2 of the valve thread gets in contact with the end M2 of the motor thread. Then the feed screw mechanism works and the assembly has completed. In this embodiment, the detent mechanism works first and then the feed screw mechanism works.

According to the first embodiment, the inner peripheral part of the large diameter hole 34 acts as the escape space that houses the motor shaft 24 not to be engaged with the male thread 38. The second value L2 is larger than the first value L1, which means the detent mechanism works first and then the feed screw mechanism works in assembling.

Until the detent mechanism works, there is no need to regulate the valve element 22 to be rotated relative to the axis and to have a tool for regulating the rotation. Thus, the assembly is to be simple and efficient.

The present disclosure is achieved in such a simple structure that the tube part 32 of the valve element 22 has the escape space having no female thread 37.

### Second Embodiment

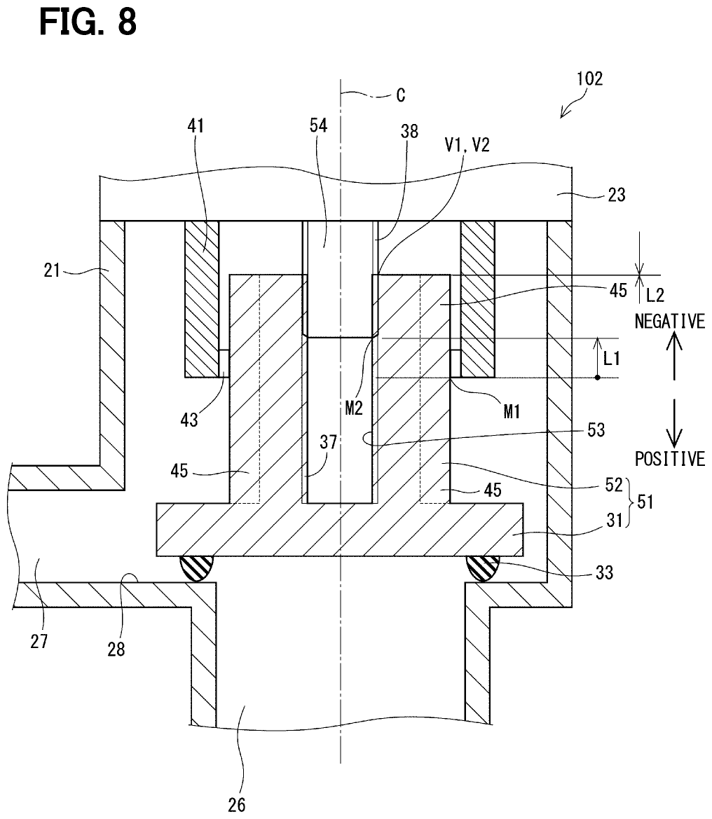

The flow control valve 10 in accordance with the second embodiment is described with reference to FIGS. 8 to 10. The substantially same structure with the first embodiment has the same symbol and it is not explained. As shown in FIG. 8, a center of a tube part 52 of a valve element 51 in the second embodiment has a hole 53 in which the motor shaft is inserted. The hole 53 extends from an end of the valve element 51 in the negative direction to the bottom wall 31 with a constant diameter. An inner peripheral part of the hole 53 has the female thread 37. The female thread 37 corresponds to the valve thread. The flow control valve in the second embodiment does not have the large diameter hole 34 corresponding to the escape space in the first embodiment.

An end of the motor shaft 54 in the positive direction, or the end M2 of the motor thread is located in the negative direction from the end M1 of the motor detent part. In the second embodiment, the end V1 of the valve detent part is located in the same position with the end V2 of the valve thread in the axial direction. Thus, the second value L2 is zero. In this embodiment, the first value L1 is negative value, so the second value L2 is still larger than the first value L1 as with the first embodiment. In this embodiment, the end M1 is closer to the valve element than the end M2 is, and the end V1 and the end V2 are located at the same position in a moving direction of the valve element.

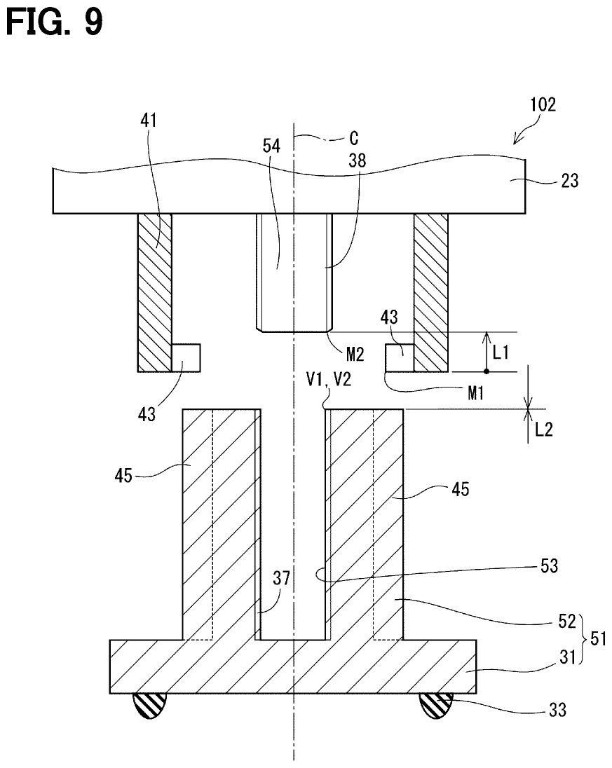

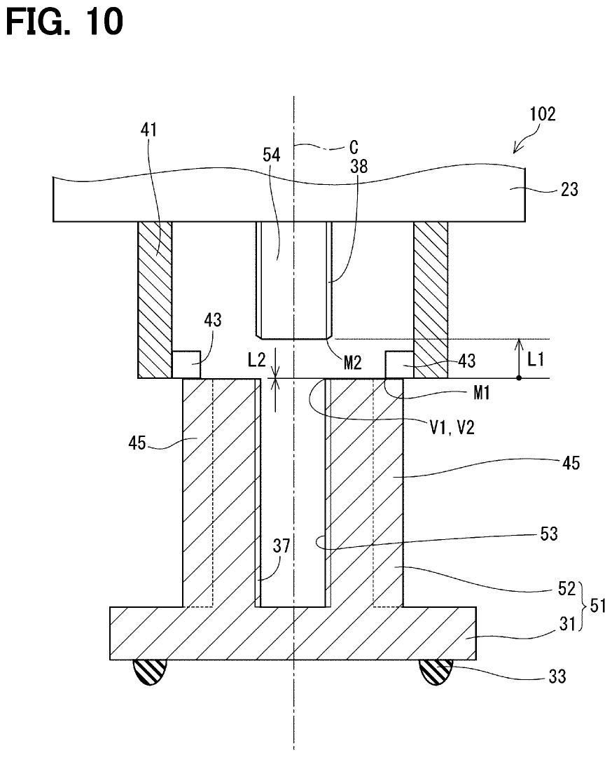

According to the second embodiment, when the valve element 51 is assembled with the motor 23 as shown in FIG. 9 and FIG. 10, the detent mechanism works first and then the feed screw mechanism works. This allows the same effect in the first embodiment.

### Other Embodiments

The flow control valves in the above-mentioned embodiments have two detent projections 45 symmetrical relative to the center axis C and two detent recesses 43 symmetrical relative to the center axis C. The detent projection 45 and the detent recess 43 form the detent mechanism. The detent recesses and the detent projections may not be symmetric relative to the axis. A number of the detent recesses 43 and the detent projections 45 may be one or plural. The cross section of the detent projection 45 and the detent recess 43 in the axial direction may not be rectangular parallelepiped. The detent projection is engaged with the detent recess to regulate the rotation of the valve element 22 in the circumference direction. Other embodiments are applicable to this disclosure.

In the second embodiment, the valve element 51 does not have the escape space. However, the valve element 51 may have the escape space, while the second value L2 is larger than the first value L1. Other embodiments are applicable to this disclosure.

The flow control valves 1 and 10 in the above-mentioned embodiments are provided at the vapor passage 16 that connects the canister 12 and the fuel tank 11 in the fuel vapor treating device 101. The flow control valve may be provided at other passage and control other fluids instead of fuel vapor.

In the above-mentioned embodiment, the valve element 22, 51 has the bottom wall 31 and the tube part 32, 52. However, the present disclosure is not limited to this structure. The housing 21 may have a coil spring energizing the valve element 22, 51 to prevent a backlash of the thread. The structure of the valve element 22, 51 and the housing 21 can be modified appropriately.

In the above-mentioned embodiments, the motor shaft 24, 54 are directly connected to the valve element 22, 51. The rotating power of the motor 23 may be transmitted to the valve element 22, 51 through a transmitting mechanism such as a worm drive mechanism and a shaft. In this case, a shaft having an end connected to the worm drive mechanism and another end connected to the valve element 22, 51 corresponds to the power transmitting shaft.

The present disclosure is not limited to the above-mentioned embodiment and may have various modifications without departing from the gist of the present disclosure.

What is claimed is:

1. A flow control valve comprising:
a housing having a passage through which fuel vapor flows from a fuel tank passage to a canister passage;
a valve element configured to get in contact with and be separated from a valve seat of the housing;
a drive member that reciprocates the valve element to get in contact with and be separated from the valve seat, the drive member and the valve element being connected with each other by a power transmitting shaft for power transmission;
a drive-member thread provided at the power transmitting shaft;
a valve thread provided at the valve element and engaged with the drive-member thread to form a feed screw mechanism;
a drive-member detent part provided at the drive member; and
a valve detent part engaged with the drive-member detent part to form a detent mechanism restricting a rotation of the valve element in a circumferential direction, wherein
when a direction where the valve element gets in contact with the valve seat is defined as a positive direction and when a direction where the valve element is separated from the valve seat is defined as a negative direction,
a first value is a positive or negative value indicating a distance from an end of the drive-member detent part in the positive direction as a start point to an end of the drive-member thread in the positive direction; and
a second value is a positive or negative value indicating a distance from an end of the valve detent part in the negative direction as a start point to an end of the valve thread in the negative direction, and
the second value is larger than the first value.

2. The flow control valve according to claim 1, wherein
the valve element has a bottom wall and a tube part extending from the bottom wall toward the drive member, a seal member being disposed on the bottom wall to be in contact with the valve seat,
the valve detent part is located at an end portion of the tube part in the negative direction,
the valve thread is provided around an inner peripheral part of the tube part, and
the inner peripheral part of the tube part has an escape space located between the end portion and the valve thread, the escape space housing the power transmitting shaft not to be engaged with the drive-member thread.

3. The flow control valve according to claim 1, wherein
one of the drive-member detent part and the valve detent part is a detent projection that protrudes outward in a radial direction orthogonal to a reciprocating movement direction of the valve element, and
the other of the drive-member detent part and the valve detent part is a detent recess that is recessed inward in the radial direction and engaged with the detent projection.

4. The flow control valve according to claim 1, wherein
the end of the drive-member thread in the positive direction is located in the negative direction from the end of the drive-member detent part in the positive direction.

5. A fuel vapor treating device comprising:
the flow control valve according to claim 1;
a fuel tank connected with the fuel tank passage; and
a canister connected with the canister passage to absorb fuel vapor generated in the fuel tank.

6. A flow control valve comprising:
a housing having a passage through which fuel vapor flows from a fuel tank passage to a canister passage;
a valve element configured to get in contact with and be separated from a valve seat of the housing;
a drive member that reciprocates the valve element to get in contact with and be separated from the valve seat, the drive member and the valve element being connected with each other by a power transmitting shaft for power transmission;
a drive-member thread provided at the power transmitting shaft;
a valve thread provided at the valve element and engaged with the drive-member thread to form a feed screw mechanism;
a drive-member detent part provided at the drive member; and
a valve detent part engaged with the drive-member detent part to form a detent mechanism restricting a rotation of the valve element in a circumferential direction, wherein
a first distance between an end of the drive-member detent part and an end of the drive-member thread in an axial direction is smaller than
a second distance between an end of the valve detent part and an end of the valve thread in the axial direction.

7. A flow control valve comprising:
a housing having a passage through which fuel vapor flows from a fuel tank passage to a canister passage;
a valve element configured to get in contact with and be separated from a valve seat of the housing;
a drive member that reciprocates the valve element to get in contact with and be separated from the valve seat, the drive member and the valve element being connected with each other by a power transmitting shaft for power transmission;
a drive-member thread provided at the power transmitting shaft;
a valve thread provided at the valve element and engaged with the drive-member thread to form a feed screw mechanism;
a drive-member detent part provided at the drive member; and
a valve detent part engaged with the drive-member detent part to form a detent mechanism restricting a rotation of the valve element in a circumferential direction, wherein
an end of the drive-member detent part is closer to the valve element than an end of the drive-member thread is, and
an end of the valve detent part adjacent to the drive member and an end of the valve thread adjacent to the drive member are located at a same position in a moving direction of the valve element.
